(19) United States
(12) Patent Application Publication
(10) Pub. No.: US 2022/0405812 A1
(43) Pub. Date: Dec. 22, 2022

(54) Forgotten Item Notification System

(71) Applicant: Capital One Services, LLC, McLean, VA (US)

(72) Inventors: Joshua Edwards, Philadelphia, PA (US); Michael Mossoba, Great Falls, VA (US); Abdelkader M'Hamed Benkreira, Brooklyn, NY (US)

(21) Appl. No.: 17/354,280

(22) Filed: Jun. 22, 2021

(51) Int. Cl. G06Q 30/02; G06Q 30/06; G06F 40/40

(52) U.S. Cl. CPC G06Q 30/0281; G06Q 30/0633; G06Q 30/0639; G06F 40/40

(57) ABSTRACT

Aspects described herein use real time transaction data to notify customers when they have forgotten to purchase an item at a merchant location. A first computing device may receive one or more items that are added to an electronic list of items to purchase, whether at merchant location or multiple locations. A second computing device operated by a financial institution entity may receive transaction data representative of a purchase of at least one item at a merchant location. The transaction data may comprise item level data representative of a specific item to purchase. Based on the transaction data, the second computing device may determine whether the specific item on the electronic list was purchased at the merchant location. When determining that the item was not purchased at the merchant location, the second computing device may determine whether the merchant location sells the specific item and when determining that the merchant location sells the item, a notification may be sent to a user that the specific item was not purchased.

### FIELD OF USE

Aspects of the disclosure relate generally to assisting a customer that an item on a shopping list was not purchased at a store. More specifically, aspects of the disclosure provide techniques for comparing transactional data from a purchase at a store to an electronic shopping list of a customer to send a notification to the customer that she forgot to purchase an available item on her shopping list form the store.

### BACKGROUND

For many individuals, weekly or even daily errands can require a great deal of time and effort to complete. Whether shopping for groceries, school supplies, clothing, or home improvement goods, many individuals look to creating shopping lists to keep them organized in managing their time. Yet there are many times in which someone goes to a store to make a purchase for various items and she forgets certain items that she was supposed to purchase. When a customer has completed a purchase, but before she leaves a store, there is a limited window of time during which she can go back and purchase missed items. If she does not purchase the missed items during that window of time, she is likely to incur a drastically larger inconvenience—either having to return to the store to get the forgotten items or to do without the desired item. Such a process may require traveling back to the store, including via a car, and then having to purchase the forgotten items. For some individuals, traveling to one or more stores may take an extra 30 minutes or hour to get to the store and then another 30 minutes or hour to get back home.

Aspects described herein may address these and other problems, and generally enable a user that has forgotten to purchase an available item from a store to be notified of this fact shortly after purchase at the store. Thus, shopping for the individual may be done in a more reliable and time efficient manner. Such a notification thereby reduces the likelihood that the individual wastes more time to travel back to retrieve the forgotten items or has to simply live with the outcome that she cannot have all of the items she had on her shopping list at the moment. Such a notification also reduces the time and resources spent in separately managing multiple electronic shopping lists for different stores.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Using real time transactional data that is annotated with item level data, aspects described herein may allow a customer to be notified when she has forgotten to purchase an item that was available at the store. An electronic shopping list of an individual may be integrated into an application for use on a mobile device or by consuming content from a third party shopping list provider. When the individual completes her purchase, the list of items she has purchased may be compared to the items on her electronic shopping list. If there are any items that the store sells that were on the electronic shopping list but were not in the item level data of what was purchased, a notification may be sent to her to remind her of the missed items on her electronic shopping list even before she leaves the store. That way, she can immediately go back with the store to retrieve and purchase any of the missing items that were identified.

In some implementations, the electronic shopping list items may be compared to the items in a transaction by using mapping to translate the purchased items from a receipt into more common named or computer understandable items, and then those translated items may be compared to the items in the electronic shopping list. Thereafter, a machine learning model may be used that is trained to determine if the store the individual had just made her purchases at sells the one or more items from the electronic shopping list that were not purchased. For example, such a model may determine whether the store associated with the receipt sells a chainsaw.

In other implementations, individuals may mark their stores they intend to buy one or more items from so that they do not get notifications from other stores that sell the item. Such implementations may work well for shared electronic shopping lists in which it is more likely that an individual forgets to purchase an item when someone else may have added the item to the shared electronic shopping list for them without telling them separately. In addition, an individual may set priorities on her items so that only items with a certain priority receive notifications.

Aspects discussed herein may provide a computer-implemented method for sending a notification to a user that one or more items was not purchased from a store that the user recently made a purchase from. For example, in at least one implementation, a first computing device may receive an item added to an electronic shopping list of items to purchase. A second computing device operated by a financial institution entity may receive transaction data. The transaction data may be representative of a purchase of at least one item at a merchant location that recently occurred. For example, when processing an authorization to make a credit card purchase at a grocery store, an individual provides a credit card or inserts a credit card into a reader to make a purchase as part of the transaction. The merchant store sends an electronic request to a financial entity of the credit card to obtain authorization to bill the transaction. Accordingly, the financial entity knows of the transaction at the time the individual is making the purchase. The transaction data may comprise item level data representative of one or more specific items. The second computing device may determine whether one or more items on the electronic shopping list was purchased at the merchant location based on the transaction data. After determining that the one or more items was not purchased at the merchant location, the second computing device may determine whether the merchant location sells the one or more items. Then, after determining that the merchant location sells the one more items, a notification may be sent to a user that the one or more items was not purchased. Thus the user can go back to purchase any forgotten items before leaving the merchant store.

Corresponding apparatus, systems, and computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing environment that may be used in implementing one or more aspects of the disclosure in accordance with one or more illustrative aspects discussed herein;

FIG. 2 illustrates an example system for sending a notification to a user regarding one or more items that was not purchased at a store but were available for purchase in accordance with one or more aspects described herein;

FIGS. 3A-3B depict an example flowchart for a method for sending a notification to a user regarding one or more items that was not purchased at a store but were available for purchase in accordance with one or more aspects described herein;

FIG. 4 depicts an example flowchart for a method for sending a notification to a user regarding a later added item for purchase in accordance with one or more aspects described herein;

FIG. 5 depicts an example flowchart for a method for sending a notification to a user regarding a later added item for purchase in accordance with one or more aspects described herein;

FIG. 6A shows an example of a user interface of an electronic shopping list in accordance with one or more aspects of the disclosure;

FIG. 6B shows an example of a user interface allowing a user to add one or more items to an electronic shopping list in accordance with one or more aspects of the disclosure; and

FIG. 7 shows an example of a notification sent to an individual that forgot to purchase one or more items from an electronic shopping list in accordance with one or more aspects of the disclosure.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. In addition, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, aspects discussed herein may relate to methods and techniques for sending a notification to a user regarding one or more items that was not purchased at a store but were available for purchase. A first computing device may receive an item added to an electronic list of items to purchase. The item added to the electronic list may be received from a second user on a different computing device. As part of adding the item to the electronic list of items, natural language processing of the received item may be implemented to perform spell correction on the item as entered by a user before being added to the electronic list of items to be purchased. In addition, a merchant identifier representative of where to purchase the item may be received. For example, a user may want the item purchased from a certain merchant store.

A second computing device operated by a financial institution entity may receive transaction data. The transaction data may be representative of a purchase of at least one item at a merchant location and it may include item level data representative of a specific item. The transaction data may be received as an electronic copy of a paper receipt and the electronic copy of the paper receipt may be processed to identify the item level data. The item level data may be received from a merchant associated with the merchant location and the item level data from the transaction data may be matched with a database of items. The database of items may include specific items associated with the item level data.

Based on the transaction data, a determination may be made as to whether the item on the electronic list was purchased at the merchant location. This determination may be performed by processing of an electronic copy of a paper receipt to determine whether the identified item level data matches the item on the electronic list. After determining that the item was not purchased at the merchant location, a determination may be made as to whether the merchant location sells the item. Such a determination may be made by identifying at least one keyword associated with the item on the electronic list, and by determining whether the at least one keyword matches at least one keyword associated with an item offered for sale at the merchant location. In addition, a threshold number of at least one keyword may be determined to match the at least one keyword associated with the item offered for sale at the merchant location.

After determining that the merchant location sells the item, a notification may be sent to a user that the item was not purchased. Such a notification may be a push notification, a text message, or a phone call to the user. Also, a second item added to the electronic list may be received and such a second item may be received from a different user. A determination that the second item added to the electronic list was added after the purchase of the at least one item at the merchant location may be made and after determining that the merchant location sells the second item, a second notification may be sent to the user that the second item was not purchased.

Still further, a second item added to the electronic list may be received and such a second item may be received from a different user. A determination that the user is at the merchant location may be made and after determining that the user is at the merchant location, a second notification may be sent to the user that the second item was added to the electronic list.

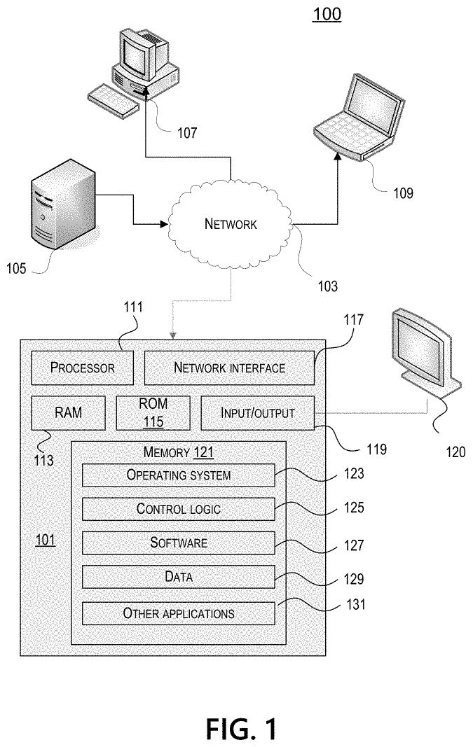

Before discussing these concepts in greater detail, however, several examples of a computing device and environment that may be used in implementing and/or otherwise providing various aspects of the disclosure will first be discussed with respect to FIG. 1.

FIG. 1 illustrates one example of a computing environment 100 and computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 101 may, in some embodiments, operate in a standalone environment. In others, computing device 101 may operate in a networked environment. As shown in FIG. 1, various network nodes 101, 105, 107, and 109 may be interconnected via a network 103, such as the Internet. Other networks may also or alternatively be used, including private intranets, corporate networks, local area networks (LANs), wireless networks, personal networks (PAN), and the like. Network 103 is for illustration purposes and may be replaced with fewer or additional computer networks. A LAN may have one or more of any known LAN topologies and may use one or more of a variety of different protocols, such as Ethernet. Devices 101, 105, 107, 109 and other devices (not shown) may be connected to one or more of the networks via twisted pair wires, coaxial cable, fiber optics, radio waves, or other communication media.

As seen in FIG. 1, computing device 101 may include a processor 111, RAM 113, ROM 115, network interface 117, input/output (I/O) interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. Processor 111 may control an overall operation of the computing device 101 and its associated components, including RAM 113, ROM 115, network interface 117, I/O interfaces 119, and/or memory 121. Processor 111 can include a single central processing unit (CPU) (and/or graphic processing unit (GPU)), which can include a single-core or multi-core processor along with multiple processors. Processor(s) 111 and associated components can allow the computing device 101 to execute a series of computer-readable instructions to perform some or all of the processes described herein. A data bus can interconnect processor(s) 111, RAM 113, ROM 115, memory 121, I/O interfaces 119, and/or network interface 117.

I/O interfaces 119 may include a variety of interface units and drives for reading, writing, displaying, and/or printing data or files. I/O interfaces 119 may be coupled with a display such as display 120. I/O interfaces 119 can include a microphone, keypad, touch screen, and/or stylus through which a user of the computing device 101 can provide input, and can also include one or more of a speaker for providing audio output and a video display device for providing textual, audiovisual, and/or graphical output.

Network interface 117 can include one or more transceivers, digital signal processors, and/or additional circuitry and software for communicating via any network, wired or wireless, using any protocol as described herein. It will be appreciated that the network connections shown are illustrative and any means of establishing a communications link between the computers or other devices can be used. The existence of any of various network protocols such as TCP/IP, Ethernet, FTP, Hypertext Transfer Protocol (HTTP) and the like, and various wireless communication technologies such as Global system for Mobile Communication (GSM), Code-division multiple access (CDMA), WiFi, and Long-Term Evolution (LTE), is presumed, and the various computing devices described herein can be configured to communicate using any of these network protocols or technologies.

Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, software 127, data 129, and other applications 131. Control logic 125 may be incorporated in and may be a part of software 127. In other embodiments, computing device 101 may include two or more of any and/or all of these components (e.g., two or more processors, two or more memories, etc.) and/or other components and/or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QoS), etc. For example, devices 101, 105, 107, 109, and others may operate in concert to provide parallel computing features in support of the operation of control logic 125 and/or software 127.

Although not shown in FIG. 1, various elements within memory 121 or other components in computing device 101, can include one or more caches including, but not limited to, CPU caches used by the processor 111, page caches used by an operating system, disk caches of a hard drive, and/or database caches used to cache content from a data store. For embodiments including a CPU cache, the CPU cache can be used by one or more processors 111 to reduce memory latency and access time. Processor 111 can retrieve data from or write data to the CPU cache rather than reading/writing to memory 121, which can improve the speed of these operations. In some examples, a database cache can be created in which certain data from a data store is cached in a separate smaller database in a memory separate from the data store, such as in RAM 115 or on a separate computing device. For instance, in a multi-tiered application, a database cache on an application server can reduce data retrieval and data manipulation time by not needing to communicate over a network with a back-end database server. These types of caches and others can be included in various embodiments, and can provide potential advantages in certain implementations of devices, systems, and methods described herein, such as faster response times and less dependence on network conditions when transmitting and receiving data.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

Although various components of computing device 101 are described separately, functionality of the various components can be combined and/or performed by a single component and/or multiple computing devices in communication without departing from the invention. Having discussed several examples of computing devices, which may be used to implement some aspects as discussed further below, discussion will now turn to various examples for sending a notification to a user regarding one or more items that was not purchased at a store but were available for purchase.

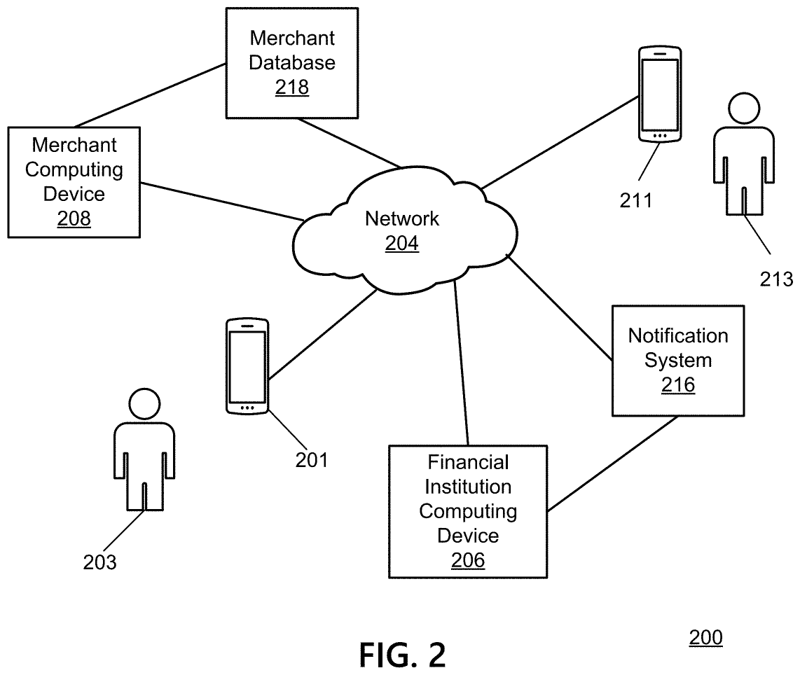

FIG. 2 shows an operating environment 100. FIG. 2 illustrates an example system 200 for sending a notification to an individual. It will be appreciated that the network connections shown are illustrative and any means of establishing a communications link between the computing devices 201, 206, 208, 211, notification system 216, and memories or databases 218 may be used. The existence of any of various network protocols such as Transmission Control Protocol/Internet Protocol (TCP/IP), Ethernet, FTP, HTTP and the like, and of various wireless communication technologies such as GSM, CDMA, WiFi, and LTE, is presumed, and the various computing devices described herein may be configured to communicate using any of these network protocols or technologies. Any of the devices and systems described herein may be implemented, in whole or in part, using one or more computing devices described with respect to FIG. 1.

FIG. 2 illustrates an example system 200 for notifying a user of a forgotten item in accordance with one or more aspects described herein. The system 200 may operate to check items purchased at a merchant against an electronic shopping list of a user. In various embodiments, a user may add one or more items to an electronic shopping list. In various embodiments, the user that will be making the purchase of items may be the individual that adds items and/or a different individual. For example, a spouse, may add one or more items to an electronic shopping list while the user is the one to make the purchases. The system 200 may perform natural language processing on any entered item for spell correction and/or to standardize entries in the electronic shopping list for the system to understand. In various embodiments, the system 200 may utilize merchant identifier data representative of where to purchase the items.

In various embodiments, a user may shop for items at a merchant using the electronic shopping list and may ultimately make a purchase. The system 200 may receive transaction data representative of a purchase of one or more items at a merchant location. The transaction data may include item level data representative of specific items that were purchased. The system 200 may map the item level data of purchased items to the electronic shopping list to determine whether any matches are present to indicate that one or more items on the electronic shopping list were purchased at the merchant location. In various embodiments, the system 200 may determine that at least one item on the electronic shopping list was not purchased. If so, system 200 may determine whether that item is available for purchase from that same merchant location. When such a determination finds that the item is available at that merchant location, a notification may be sent to the user that made the purchase to remind her that purchase of the item was forgotten. The system 200 may send such a notification very soon (e.g., within 5 minutes, so that a user may be in the parking lot) after completion of the transaction in order to allow the user to immediately go back and obtain any forgotten items.

As shown in FIG. 2, the system 200 may include user 203, user 213, user computing device 201, user computing device 211, a network 204, a financial institution computing device 208, a notification system 216, a merchant computing device 208, and/or a merchant database 218. The user computing devices 201 and 211 may be any type of computing device including any computing device depicted and described in relation to FIG. 1. In various embodiments, the user computing devices 201 and 211 may be, for example, a smartphone, a laptop, or a tablet. In various embodiments, the user computing devices 201 and 211 may be a portable wireless device. Reference is made herein to the system 200 for convenience only as it is to be understood that the users 203 and 213 are actors interacting with the other components depicted in FIG. 2. Accordingly, in various embodiments, the system 200 may not include the users 203 and 213.

The user computing device 201 may be associated with the user 203 and the user computing device 211 may be associated with user 213. The user 203 may use the user computing device 201 to add items to an electronic shopping list, to check items off an electronic shopping list, or to receive notifications of items being added to the electronic shopping list by other users (e.g., user 213 using user computing device 211 and/or notifications that user 203 forgot to purchase an item on the electronic shopping list). User 213 may perform the same actions, done by user 203 with the user computing device 201, with the user computing device 211. Any of a number of users 203 and 213 may have access to a shared electronic shopping list for adding items to, checking items off, and deleting items from the list. The shared electronic shopping list may be an application operating on the user computing device 201 and/or 211. An application operating on the user computing device 201 and/or 211 may be an application associated with the financial institution computing device 206.

The network 204 may communicatively couple each of the elements shown in FIG. 2 with each other, including the user computing devices 201 and 211, the financial institution computing device 206, the notification system 216, the merchant computing device 208, and/or the merchant database 218. The network 204 may be any type of communications and/or computer network. The network 204 may include any type of communication mediums and/or may be based on any type of communication standards or protocols. The network 204 may be the same or similar to the network 103 in FIG. 1. The network 204 enables data or other information to be shared between the various devices in FIG. 2.

The financial institution computing device 206 may be any type of computing device including any computing device depicted and described in relation to FIG. 1. In various embodiments, the financial institution computing device 206 may be associated with a financial institution. In various embodiments, the financial institution computing device 206 may represent one or more computing devices and/or a computer network associated with the financial institution. In various embodiments, the financial institution computing device 206 may include one or more computers, servers, and/or databases. The financial institution may be a bank, credit union, credit card company, or any other type of financial institution that may provide one or more financial accounts to an individual.

In various embodiments, the user 203 associated with the user computing device 201 (and similarly the user 213 associated with the user computing device 211) may have one or more financial accounts with the financial institution associated with the financial computing device 206. In various embodiments, the user 203 associated with the user computing device 201 may have a checking account, a savings account, a line of credit, and/or a credit card account provided through the financial institution associated with the financial institution computing device 206. In general, the user 203 associated with the user computing device 201 may have any type of financial account with the financial institution associated with the financial institution computing device 206.

In various embodiments, the user 203 may use the user computing device 201 to attempt to conduct a financial transaction using (e.g., funded by) an account maintained by the financial institution computing device 206. In some embodiments, the user 203 may use a credit card account stored in the user computing device 201 in communication with a merchant computing device 208 to conduct such a purchase. In still other embodiments, the user 203 may use a physical credit card with a merchant computing device 208 to conduct such a purchase. Any such attempt by the user 203 may trigger the system 200 to authorize the financial transaction. For example, any such attempt by the user 203 to make a purchase for items at a merchant location may cause the system 200 to operate to attempt to authenticate the identity of the user 203, verify the account associated with the financial institution computing device 206, authorize the financial transaction to ensure the user 203 is indeed the individual associated with the financial account and therefore authorized to perform the requested transaction, that spending limits have not been acceded or restrictions have not been imposed on the financial account, and coordinate with the merchant computing device 208 to authorize the purchase.

In various embodiments, the merchant computing device 208 may provide item level data as part of a receipt to user 203 and/or user computing device 201 for a transaction. The item level data may include data representative of the item(s) purchased at the merchant location as part of the transaction. In some embodiments, item level data may include textual data identifying a purchased item as part of the receipt. For example, an entry of “AAABatt” with a price of $9.99 may be item level data for AAA type batteries that had a cost of $9.99 for the item. Another entry of “MShirtSM” with a price of $14.99 may be item level data for a men's size small T-shirt that had a cost of $14.99 for the item. In some embodiments, item level data may be whole words, portions of words, acronyms, numbers, and/or a combination of one or more letters and one or more numbers.

In various embodiments, the merchant computing device 208 may access merchant database 218 in order to identify item level data for items to provide in a receipt for a transaction. Item level data may be different for different merchants. System 200 may include a plurality of different merchant computing devices 208 and/or merchant databases 218 at one merchant location. In some embodiments, system 200 may include a plurality of different merchant computing devices 208 for a plurality of different merchants. For example, a grocery store may be one merchant that has at least one merchant computing device 208 and merchant database 218 for use in purchases at the grocery store, while a hardware store may be another merchant that has at least one merchant computing device 208 and merchant database 218 for use in purchases at the hardware store.

Any of a number of different merchant locations of the same merchant and/or different merchants may be included within system 200. In addition, a plurality of different financial institution computing devices 206 may be included within system 200, including a plurality of different financial institution computing devices 206 for one financial institution and/or a plurality of different financial institution computing devices 206 for multiple financial institutions.

The system 200 may include one or more notification system 216 to notify a user 203, via user computing device 201, that she has forgotten to purchase an item from her electronic shopping list that is available for purchase at a merchant location where the user 203 just recently made a purchase. Illustrative notifications include a push notification to the user computing device 201, a text message to the user computing device 201, and/or a phone call to the user computing device 201 among other types of notifications.

Discussion will now turn to functional descriptions of the operations performed by one or more components for the system 200 for notifying a user.

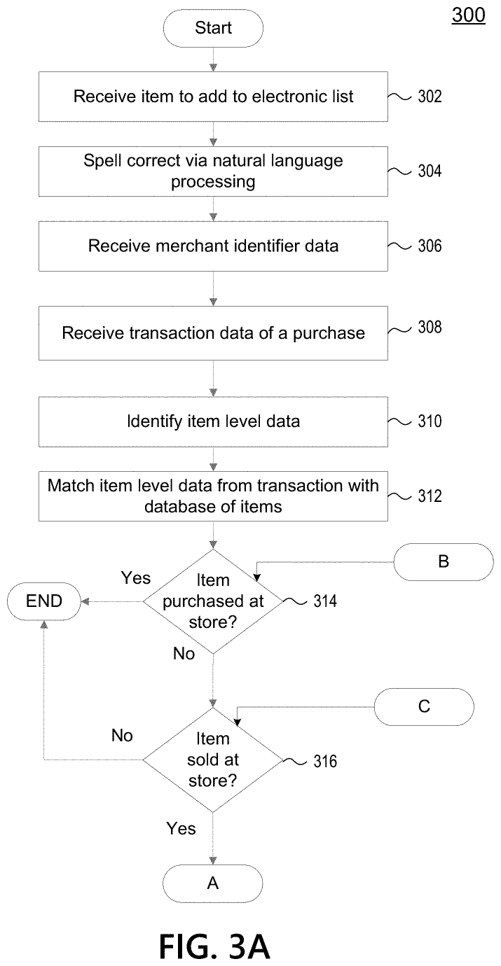

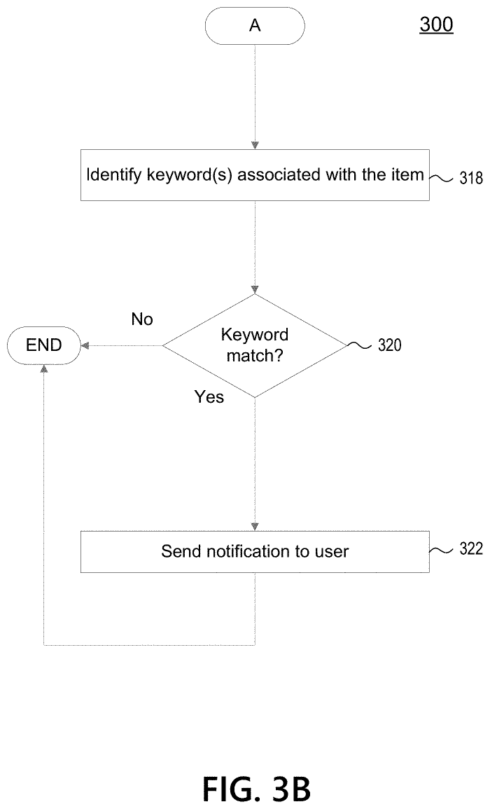

FIGS. 3A-3B depict an example flow diagram of an example method 300 for sending a notification to a user regarding one or more items that was not purchased at a store but were available for purchase. Some or all of the steps of method 300 may be performed using a system that comprises one or more computing devices as described herein, including, for example, computing device 101, computing devices in FIG. 1, and/or computing devices in FIG. 2.

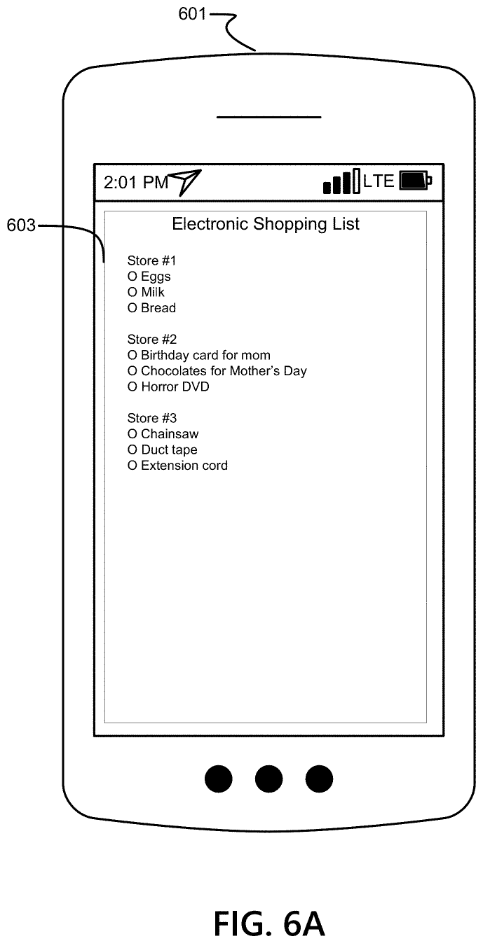

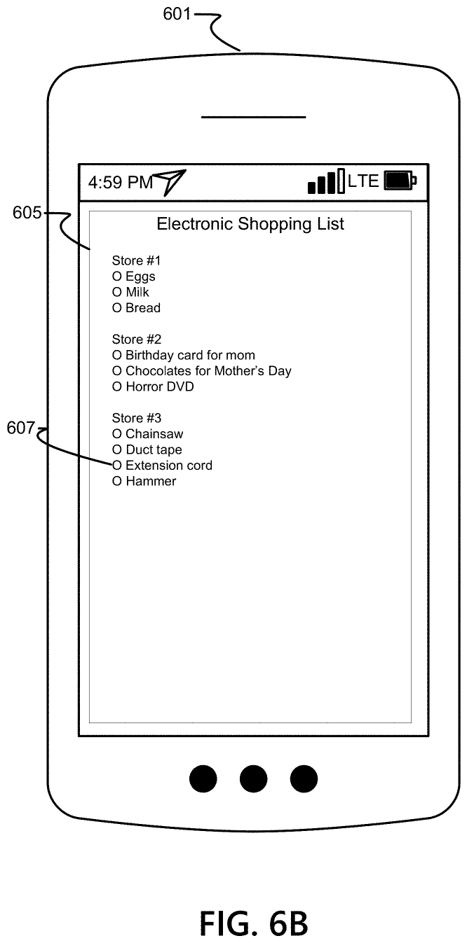

At step 302, the system may receive an item to be added to an electronic list of items to purchase. In various embodiments, a user may open an electronic list application on the user's mobile computing device in order to add an item to the electronic list for use when shopping. Such a user may be a user who will be performing the shopping at one or more merchant locations, such as user 203 using user computing device 201 in FIG. 2, or may be another user that has access to the electronic list but will not be performing the shopping, such as user 213 using user computing device 211 in FIG. 2. FIG. 6A shows an example of a user interface 603 of an electronic list in accordance with one or more aspects of the disclosure. FIG. 6A shows a user computing device 601 that is displaying a user interface 603 for an electronic shopping list. In this example, the electronic list 603 may include items for three different stores, such as a grocery store for store #1, a gift store for store #2, and a hardware store for store #3. Any of the items included therein may have been added by a user that will be performing shopping for the items and/or another user. The electronic list shown in user interface 603 may be a shared electronic list accessible by a plurality of users with access to the account associated with the shared electronic list. FIG. 6B shows an example of a user interface 605 where a user has added an item 607 to an electronic shopping list in accordance with one or more aspects of the disclosure. FIG. 6B may be an example where a user accessing user interface 603 in FIG. 6A has added item 607, e.g., “Hammer” to the electronic list. In this example, a user has added to the existing shared electronic list to have a shopper purchase a hammer from store #3. As shown in the examples of FIG. 6A and FIG. 6B, a user that is shopping may not have added item 607 to the electronic list. In FIG. 6A, the user that is shopping may have seen the electronic list and looked to proceed with shopping at a merchant location for store #3, e.g., a hardware store. That same user may not have been aware that item 607 in FIG. 6B was added by another user that has access to the shared electronic list of items. Accordingly, the user that is shopping may not have even been aware that she should be purchasing a hammer, item 607, when shopping at store #3.

In step 304, natural language processing of the entry in the electronic list in step 302 may be performed. The natural language processing may perform spell correction before the item is added to the electronic list. For example, in the example of FIG. 6B, a user that entered item 607 into the electronic shopping list may have typed in “hamer” as the entry. Step 304 may receive the entry of “hamer” and, using natural language processing, may add the item to the electronic list in FIG. 6B as “Hammer.” The natural language processing in step 304 may perform more than simple spell correction. Natural language processing in step 304 may identify synonyms for entries by a user. Natural language processing in step 304 also may identify names or certain identification for entries by a user as being directed to a particular person. For example, natural language processing in step 304 may identify an entry of “mom” or “mother” or “Betty” as all being the same person. In order to identify each as being the same individual, user tagging data may be included for an account of users of a shared electronic list. The user tagging data may include information such as names of users of the account, relatives and/or friends of users of the account, and interests of users, relatives, or friends of users of the account. Accordingly, an item entry of “gift for mom” may be processed by the natural language processing in step 304 to note that “mom” is “Betty,” the mother of a user of the account and that Betty's interest for a “gift” include college basketball, comedy movies, and car restoration. The natural language processing in step 304 may utilize a machine learning model to match entries of users with account information and to learn for subsequent purchases more efficient matching techniques for a specific user and for groups of users.

Moving to step 306, the system may receive a merchant identifier representative of where to purchase the item that is received in step 302. In the example of FIG. 6B, the store number may be a merchant identifier and, in step 306, the system may have received the merchant identifier for store #3 (e.g., a hardware store). In various embodiments, the electronic list may be a single list of items with no specific designation of merchant identifiers on a per item basis. In the example of FIGS. 6A and 6B, merchant identifiers “Store #1,” “Store #2,” and “Store #3” are shown. Although not a requirement, a merchant identifier may be an indication of where to purchase the particular item or items associated with the merchant identifier.

Moving to step 308, the system may receive transaction data representative of a purchase of one or more items at a merchant location. The transaction data may include item level data representative of specific items included in the purchase. In various embodiments, the transaction data may include item level data from a merchant associated with the merchant location where the purchase recently occurred. For example, step 308 may occur when a user has made a purchase for three items, such as eggs, milk, and bread, at a particular grocery store as illustratively shown in FIG. 6A and FIG. 6B under “Store #1.” “Store #1” may be representative of a particular merchant location and/or merchant. Accordingly, the transaction data in step 308 may be an electronic receipt for the purchase of any items from “Store #1.” Such an electronic receipt may be an electronic copy of a paper receipt that a shopper may receive when completing a purchase at the merchant location.

In step 310, the system may perform processing of an electronic receipt to identify the item level data included therein. Identification of item level data may include identifying data fields in the electronic receipt that specify a particular item and a corresponding cost for that item. As described in a previous example, item level data may include textual data identifying a purchased item as part of the receipt. For example, an entry of “OrgBwnEggsLDzn” with a price of $6.99 may be item level data for a dozen organic large brown eggs that had a cost of $6.99 for the item. Another entry of “AIVMlkG” with a price of $4.99 may be item level data for a gallon sized vanilla sweetened almond milk that had a cost of $4.99 for the item. Accordingly, step 310 includes identifying “OrgBwnEggsDzn” and “AIVMlkG” as item level data in the transaction data.

Proceeding to step 312, the system may match the item level data from the transaction data with a database of items. The database of items may include specific items associated with the item level data. Such item level data may be received from and/or retrieved from a merchant database 218. For the above grocery store example, the item level data of “OrgBwnEggsDzn” and “AIVMlkG” may be matched to a specific dozen organic large brown eggs and a specific gallon sized vanilla sweetened almond milk. The matching may be conducted by identifying the items mapped to the entries of “OrgBwnEggsDzn” and “AIVMlkG” in a merchant database 218.

In step 314, a determination may be made as to whether one or more items on the electronic list was purchased at the store where the purchase just occurred. The determination in step 314 may be for a specific item, for all items, or for a portion of items, such as the items listed under “Store #1” in FIG. 6B. In the example of FIG. 6B, when a user makes a purchase at store #1, transaction data of the purchase may be received and processed to determine which items from the user interface 605 were purchased. If, for example, all three items within user interface 605 for store #1 were purchased, the process may end. Alternatively, if one or more items was not purchased, the process may move to step 316.

In step 316, a determination may be made as to whether one or more items, on the electronic list that was not purchased, is sold by the store where the purchase just occurred. In the example of FIG. 6B, when a user makes a purchase at store #1, transaction data of the purchase may be received and processed to determine which items from the user interface 605 were not purchased. Then, in step 316, if “Bread” was not purchased, the determination may be made as to whether store #1 sells the item identified as “Bread” in user interface 605. If, for example, “Bread” within user interface 605 for store #1 is an item that is not sold at store #1, the process may end. Alternatively, if one or more items are sold at the store, the process may move to step 318.

In various embodiments, a merchant database 218 may include data of items offered for sale by the merchant associated with the merchant database 218. Upon determining that one or more items were not purchased in step 314, merchant database 218 may be accessed in step 316 and the items not purchased may be checked against items in the merchant database 218. Merchant database 218 may include quantity information for items offered for sale by a respective merchant. Accordingly, for an entry in an electronic list that is plural, the quantity information for an item may be used to ensure that the merchant location has enough of the item included within the electronic list.

In step 318, the system may identify one or more keywords associated with the item on the electronic list. Step 318 may be part of step 316. One or more keywords associated with the unpurchased item on the electronic list may be identified in order to determine whether the store sells the item. For example, as shown in FIG. 6A, the user interface 603 of the electronic list for store #2 includes an item shown as “Horror DVD.” Such an item entry by a user may equate to having the shopper purchase a horror movie on DVD. Perhaps there is a new horror movie recently offered for sale and the electronic list is an entry by a user to purchase it. Keywords for a particular horror movie in DVD format offered for sale by a merchant may include the title of the horror movie, actresses and actors within the movie, character names within the movie, “horror” as a genre of the movie, “DVD” for the format of the movie, and/or other keywords. Step 318 may include identifying these keywords associated with the item of “Horror DVD” shown in FIG. 6A.

Proceeding to step 320, the system may make a determination as to whether the one or more keywords match at least one keyword associated with an item offered for sale by the merchant location. In step 320, the system may match any respective keywords to identify items offered for sale by the merchant that would meet the item entry in the electronic list for an item entry that was not purchased but could have been. Thus, for the example of “Horror DVD” in the user interface 603 of the electronic list in FIG. 6A, a keyword of “horror” would match a genre designation for one or more items sold by the merchant where a purchase was just made and would also match a keyword of an unpurchased item in the electronic list. If, for example, at least one keyword match does not exist, the process may end. Alternatively, if one or more keywords match, the process may move to step 322. In some embodiments, a threshold number of keyword matches may be determined before proceeding to step 322. In some embodiments when a plurality of one item is included in an electronic list, the system further may determine that there is sufficient quantity of the item being offered for sale at the store.

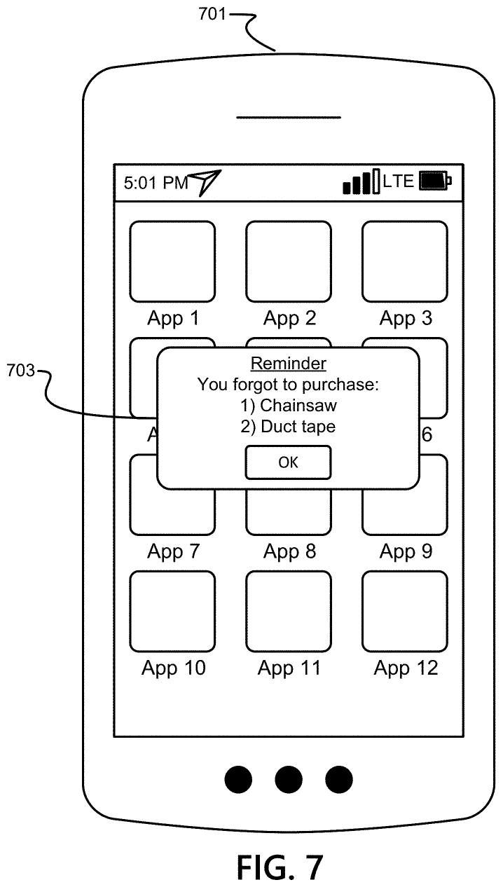

In step 322, upon determining that the store sells the item, the system may send a notification to the user that the item was not purchased. Illustrative notifications to the user include a phone call to the user, a text message to the user, or a push notification to the user. FIG. 7 shows an example of a push notification 703 sent to an individual that forgot to purchase one or more items from an electronic shopping list. Push notification 703 is shown on a user's computing device 701. In this example with respect to store #3 in FIGS. 6A and 6B, the user of computing device 701 may have gone to store #3 and purchased an extension cord and hammer as noted in user interface 603 and 605. However, the system may have determined that the item entries of “chainsaw” and “duct tape” were items that were not purchased but were available for purchase at store #3. Accordingly, as noted for step 322 in FIG. 3B, push notification 703 may be sent to the user's computing device 701 where the notification informs the user that she could have purchased a “chainsaw” and “duct tape” at store #3 as indicated on the user's electronic list. With such a notification 703, the user may immediately go back and purchase the two forgotten items from the store. Following the notification sent in step 322, method 300 may end. In various embodiments, a notification may include merchant information for location of the forgotten item quickly. For example, a notification may indicate that the forgotten item may be found on aisle 5 of the merchant location. Such data as to location of items within a merchant location may be accessible via a merchant database, such as merchant database 218 in FIG. 2. Such a merchant database may include inventory data in addition to location data for each inventory item.

One or more steps of the example may be rearranged, omitted, and/or otherwise modified, and/or other steps may be added.

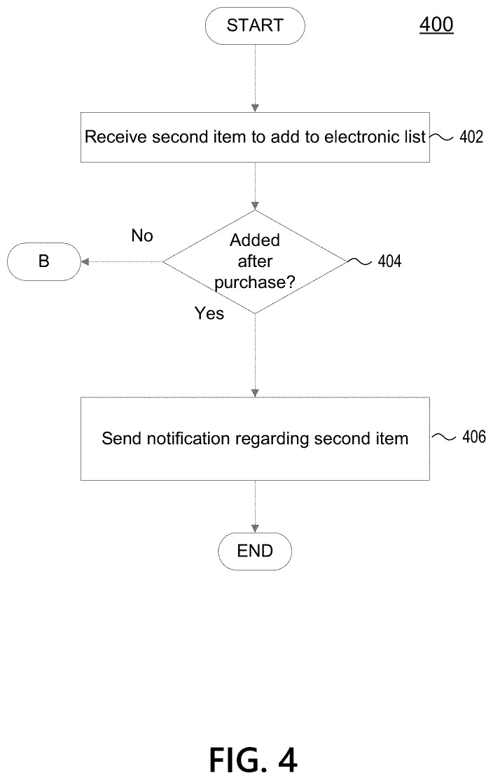

FIG. 4 depicts a flowchart for a method 400 for sending a notification to a user regarding a later added item for purchase in accordance with one or more aspects described herein. FIG. 4 illustratively ties into method 300 described with respect to FIGS. 3A and 3B. Some or all of the steps of method 400 may be performed using a system that comprises one or more computing devices as described herein, including, for example, computing device 101, or computing devices in FIG. 1, and computing devices in FIG. 2.

At step 402, the system may receive an additional item to be added to an electronic list of items to purchase. Step 402 may be similar to step 302 in FIG. 3A. FIG. 6B shows an example of a user interface 605 where a user has added an item 607 to an electronic shopping list. In FIG. 6B, a user has added item 607, e.g., “Hammer” to the electronic list. In this example, a user has added to the existing shared electronic list to have a shopper purchase a hammer from store #3.

In step 404, a determination may be made by the system as to whether the additional item added to the electronic list in step 402 was added after completing the purchase of one or more items at the merchant location. For example, if the item “hammer” 607 was not added in FIG. 6B after the user had already made a purchase at store #3, then the process moves to step 314 in FIG. 3A. Else, method 400 moves to step 406.

In step 406, the system may send a notification to the user that the additional item was not purchased. As part of step 406, the system may determine whether the merchant location sells the additional item. Such a similar step is described for step 316 in FIG. 3A. Similar to step 322, illustrative notifications to the user in step 406 include a phone call to the user, a text message to the user, and a push notification to the user. With a notification in step 406, the user may immediately go back and purchase the additional item from the merchant. Following the notification sent in step 406, method 400 may end.

One or more steps of the example may be rearranged, omitted, and/or otherwise modified, and/or other steps may be added.

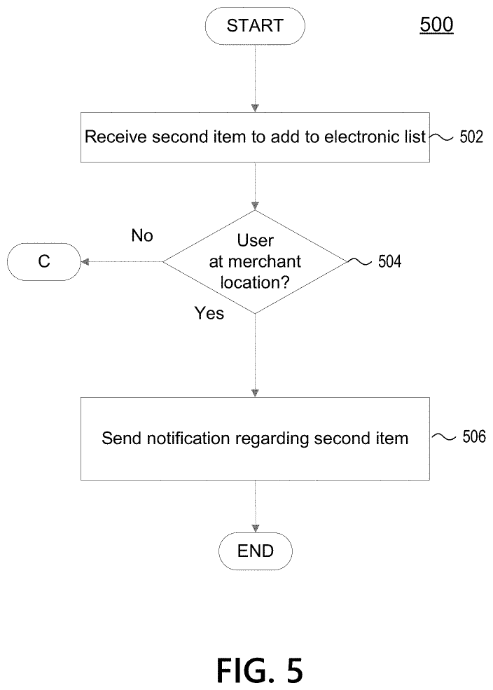

FIG. 5 depicts a flowchart for another method 500 for sending a notification to a user regarding a later added item for purchase. FIG. 5 illustratively ties into method 300 described with respect to FIGS. 3A and 3B. Some or all of the steps of method 500 may be performed using a system that comprises one or more computing devices as described herein, including, for example, computing device 101, or computing devices in FIG. 1, and computing devices in FIG. 2.

At step 502, the system may receive an additional item to be added to an electronic list of items to purchase. Step 502 may be similar to step 402 in FIG. 4 and step 302 in FIG. 3A. FIG. 6B shows an example of a user interface 605 where a user has added an item 607 to an electronic shopping list. As described herein, in FIG. 6B, a user has added item 607 (e.g., “Hammer”) to the electronic list. In this example, a user has added to the existing shared electronic list to have a shopper purchase a hammer from store #3.

At step 504, a determination may be made by the system as to whether the user is currently at the merchant location. One manner for such a determination is by utilizing location data of a user's computing device that specifies a geographic location of the user's computing device, and thus when shopping, the user of the computing device. Another manner for such a determination may include the system identifying that a user is checking off items with the electronic list while shopping. For example, a user may be shopping at store #1 when the additional item is received in step 502. Store #1 may not be the store associated with the item being added in step 502. The system may determine that the user is shopping at store #1 upon identifying the user submitting an input to check off the item form the electronic list. For example, in user interface 605 in FIG. 6B, each item is shown with a circle beside the item. The circle may be filled in or checked off by a user while shopping to help the user know what has and what has not been purchased. The system may be able to track the user checking off items to be able to determine whether the user is in a particular merchant location as noted in step 504. In various embodiments, a user may be able to input that she has started shopping at a specific merchant location. Thus, location data checking need not be used. If the determination is that the user is not in the merchant location, then the process moves to step 316 in FIG. 3A. Else, method 500 moves to step 506.

In step 506, the system may send a notification to the user that the additional item was added to the list. Similar to steps 322 and 406, illustrative notifications to the user in step 506 include a phone call to the user, a text message to the user, and a push notification to the user. With a notification in step 506, the user may note to purchase the additional item when at the particular merchant location. Following the notification sent in step 506, method 500 may end.

One or more steps of the example may be rearranged, omitted, and/or otherwise modified, and/or other steps may be added.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method comprising:
receiving, by a first computing device, an item added to an electronic list of items to purchase;
receiving, by a second computing device operated by a financial institution entity, transaction data representative of a completed purchase of at least one item at a merchant location, wherein the transaction data comprises item level data representative of a specific item;
based on the transaction data, determining, by the second computing device, whether the item on the electronic list was purchased at the merchant location;
upon determining that the item was not purchased at the merchant location, determining, by the second computing device, whether the merchant location sells the item; and
upon determining that the merchant location sells the item, sending a notification to a user that the item was not purchased, wherein the notification to the user is configured to be superimposed over any displayed content on the first computing device.

2. The method of claim 1, wherein the receiving the transaction data comprises receiving the item level data from a merchant associated with the merchant location.

3. The method of claim 1, wherein the receiving the transaction data comprises matching the item level data from the transaction data with a database of items, the database of items comprising specific items associated with the item level data.

4. The method of claim 1, wherein the receiving the transaction data comprises:
receiving an electronic copy of a paper receipt of the completed purchase; and
performing, by the second computing device, processing of the electronic copy of the paper receipt to identify the item level data.

5. The method of claim 1, wherein the receiving the item added to the electronic list comprises performing, by the first computing device, natural language processing of the item to perform spell correction before being added to the electronic list.

6. The method of claim 1, wherein the first computing device and the second computing device are operated by the financial institution entity.

7. The method of claim 6, wherein the first computing device and the second computing device are the same computing device.

8. The method of claim 1, wherein the determining whether the item on the electronic list was purchased at the merchant location comprises performing processing of an electronic copy of a paper receipt of the completed purchase to determine whether the item level data matches the item on the electronic list.

9. The method of claim 1, wherein the notification to the user comprises at least one of:
a push notification to the user, or
a text message to the user.

10. The method of claim 1, wherein the determining whether the merchant location sells the item comprises:
identifying at least one keyword associated with the item on the electronic list; and
determining whether the at least one keyword matches at least one keyword associated with an item offered for sale by the merchant location.

11. The method of claim 10, further comprising determining whether a threshold number of at least one keyword matches the at least one keyword associated with the item offered for sale by the merchant location.

12. The method of claim 1, wherein the item added to the electronic list is received, via a third computing device, from a second user.

13. The method of claim 1, further comprising:
receiving, by the first computing device, a second item added to the electronic list, wherein the second item added to the electronic list is received, via a third computing device, from a second user;
determining that the second item added to the electronic list was added after the completed purchase of the at least one item at the merchant location; and
upon determining that the merchant location sells the second item, sending a second notification to the user that the second item was not purchased.

14. The method of claim 1, further comprising:
receiving, by the first computing device, a second item added to the electronic list, wherein the second item added to the electronic list is received, via a third computing device, from a second user;
determining that the user is at the merchant location; and
upon determining that the user is at the merchant location, sending a second notification to the user that the second item was added to the electronic list.

15. The method of claim 1, wherein the receiving the item added to the electronic list comprises receiving a merchant identifier representative of where to purchase the item.

16. A computing device comprising:
one or more processors; and
memory storing instructions that, when executed by the one or more processors, cause the computing device to:
receive an item added to an electronic list of items to purchase, wherein the computing device is operated by a financial institution entity;
receive transaction data representative of a completed purchase of at least one item at a merchant location, wherein the transaction data comprises item level data representative of a specific item;
based on the transaction data, determine whether the item on the electronic list was purchased at the merchant location;
upon determining that the item was not purchased at the merchant location, determine whether the merchant location sells the item; and
upon determining that the merchant location sells the item, notify a user that the item was not purchased, wherein a notification to the user is configured to be superimposed over any content on the computing device.

17. The computing device of claim 16, wherein the instructions, when executed by the one or more processors, cause the computing device to:
receive an electronic copy of a paper receipt of the completed purchase; and
perform processing of the electronic copy of the paper receipt to identify the item level data.

18. The computing device of claim 16, wherein the instructions, when executed by the one or more processors, cause the computing device to:
identify at least one keyword associated with the item on the electronic list; and
determine whether the at least one keyword matches at least one keyword associated with an item offered for sale by the merchant location.

19. A non-transitory computer readable medium comprising instructions, that when executed by one or more processors, cause a computing device to:
receive an item added to an electronic list of items to purchase, wherein the computing device is operated by a financial institution entity;
receive transaction data representative of a completed purchase of at least one item at a merchant location, wherein the transaction data comprises item level data representative of a specific item;
based on the transaction data, determine whether the item on the electronic list was purchased at the merchant location;
upon determining that the item was not purchased at the merchant location, determine whether the merchant location sells the item; and
upon determining that the merchant location sells the item, notify a user that the item was not purchased, wherein a notification to the user is configured to be superimposed over any displayed content on the first computing device.

20. The non-transitory computer readable medium of claim 19, wherein the instructions, when executed by the one or more processors, cause the computing device to:
receive a second item added to the electronic list, wherein the second item added to the electronic list is received, via a second computing device, from a second user;
determine that the second item added to the electronic list was added after the completed purchase of the at least one item at the merchant location; and
upon determining that the merchant location sells the second item, send a second notification to the user that the second item was not purchased.
